(19) United States
(12) Patent Application Publication
(10) Pub. No.: US 2018/0137131 A1
(43) Pub. Date: May 17, 2018

(54) DATA RETENTIONS

(71) Applicant: HEWLETT PACKARD ENTERPRISE DEVELOPMENT LP, Houston, TX (US)

(72) Inventors: Ramesh Kannan Karuppusamy, Tiruppur (IN); Arun Vishnu Pathanipadath Karthikeyan, Ernakulam (IN); Rajkumar Kannan, Bangalore (IN)

(21) Appl. No.: 15/577,593

(22) PCT Filed: Jun. 3, 2015
(86) PCT No.: PCT/US15/33989

§ 371 Date: Nov. 28, 2017

(51) Int. Cl. G06F 17/30

(52) U.S. Cl. CPC G06F 17/30085; G06F 17/30073; G06F 17/30371

(57) ABSTRACT

An example computing device includes a data storage device and a controller coupled to the data storage device. The data storage device includes a storage segment. The controller is to, in response to receiving a retention feature activation of the storage segment, compute a retention enabled time of the storage segment; in response to receiving a retention request associated with data in the storage segment, compute an absolute segment survival time based on the retention enabled time and compute a retention expiry time of the data based on the absolute segment survival time. The retention request is associated with a retention period. The controller is further to determine whether the retention period has lapsed based on the retention expiry time.

### BACKGROUND

Companies or institutions that operate in regulated industries, such as a bank, may retain data in an unmodifiable and non-erasable archive for a particular duration as required by regulations.

### BRIEF DESCRIPTION OF THE DRAWINGS

Some examples of the present application are described with respect to the following figures:

FIG. 1 is a block diagram of a computing device including a data storage device to retain a data in a storage segment during a retention period, according to an example;

FIG. 2 is a block diagram of a computing device including a data storage device to retain a data in a storage segment during a retention period, according to another example;

FIG. 3 is a block diagram of a computing device including a data storage device to retain a data in a storage segment during a retention period, according to another example;

FIG. 4 is a flowchart illustrating a method of operation at a computing device including a data storage device to retain a data in a storage segment during a retention period, according to an example; and

FIG. 5 is a flowchart illustrating a method of operation at a computing device including a data storage device to retain a data in a storage segment during a retention period, according to another example.

### DETAILED DESCRIPTION

To retain data in archive for a particular duration, a system clock of a computing device that controls a data storage device where the data is stored may be used to keep track of the particular duration. However, the system clock may be susceptible to being altered so that the particular duration expires prematurely. Thus, a reliability of a data retention operation may be reduced.

Examples described herein provide a computing device including a data storage device and a controller coupled to the data storage device. The data storage device may include storage segment. The controller may, in response to receiving a retention feature activation of the storage segment, compute a retention enabled time of the storage segment. The controller may also, in response to receiving a retention request associated with a data in the storage segment, compute an absolute segment survival time based on the retention enabled time and compute a retention expiry time of the data based on the absolute segment survival time. The retention request may be associated with a retention period. The controller may further to determine whether the retention period has lapsed based on the retention expiry time. In this manner, examples described herein may increase a reliability of a data retention operation.

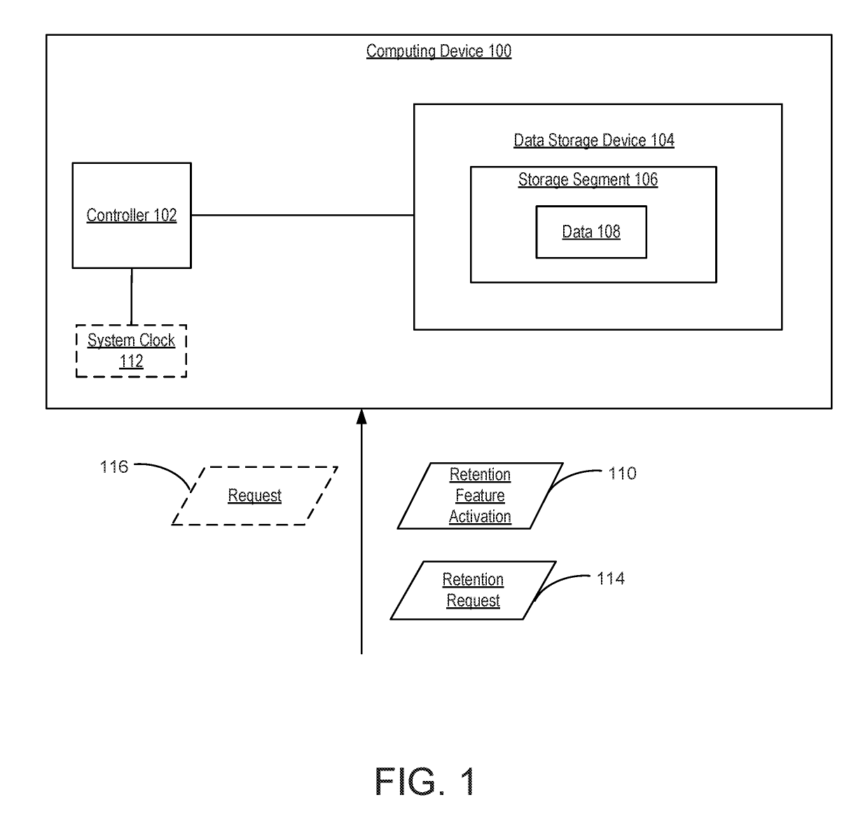

Referring now to the figures, FIG. 1 is a block diagram of a computing device 100 including a data storage device to retain a data in a storage segment during a retention period, according to an example. Computing device 100, for example, a web-based server, a local area network server, a cloud-based server, a notebook computer, a desktop computer, an all-in-one system, a tablet computing device, a mobile phone, an electronic book reader, or any other electronic device suitable for retaining data in a data storage device based on a retention period. Computing device 100 may include a controller 102 and a data storage device 104.

Controller 102 may be a central processing unit (CPU), a semiconductor-based microprocessor, and/or other hardware devices suitable for retrieval and execution of instructions stored in a computer-readable storage medium (not shown in FIG. 1). Controller 102 may control operations of data storage device 104. Data storage device 104 may be, for example, a hard disk drive, a flash drive, a solid state drive, a redundant array of inexpensive disks (RAID) system, a network-attached storage (NAS) system, or any other storage device suitable for retaining data.

Data storage device 104 may include a storage segment 106. Storage segment 106 may be a unit of data storage. In some examples, storage segment 106 may correspond to a storage volume. Data 108 may be stored in storage segment 106. In some examples, data 108 may be stored as a file.

During operation, computing device 100 may receive a retention feature activation 110 associated with storage segment 106. Retention feature activation 110 may be activated by a user of computing device 100 or another computing device. Retention feature activation 110 may be received via an input device or a network interface of computing device 100. In response to receiving retention feature activation 110, controller 102 may compute a retention enabled time. For example, controller 102 may set the retention enabled time as the current system time. Controller 102 may determine the current system time based on a system clock 112 of computing device 100. The current system time may indicate a time and a date (e.g., a day, a month, and/or a year). In some examples, system clock 112 may be implemented using instructions executable by controller 102. System clock 112 may generate the current system time via a network time protocol (NTP). In some examples, system clock 112 may be implemented as a hardware clock.

In response to receiving retention feature activation 110, controller 102 may also compute a segment survival time. For example, controller 102 may set the segment survival time to an initial value zero. Controller 102 may further compute a base kernel uptime. For example, controller 102 may set the base kernel uptime to a current kernel uptime. The current kernel uptime may be an amount of time that computing device 100 has been in operation without rebooting or crashing. In some examples, the current kernel uptime may be provided by an operating system executing on computing device 100. As described in more detail below, controller 102 may periodically update the segment survival time and the base kernel uptime so that the segment survival time and the base kernel uptime stay current.

Computing device 100 may receive a retention request 114 associated with data 108. Retention request 114 may indicate that data 108 is to be retained in data storage device 104 for a particular period of time. The particular period of time may correspond to a retention period. During the retention period, data 108 may not be modified or erased.

In response to receiving retention request 114, controller 102 may compute an absolute segment survival time based on the retention enabled time and based on the segment survival time. Controller 102 may compute a retention expiry time of data 108 based on the absolute segment survival time and based on the retention period. Controller 102 may determine whether the retention period has lapsed based on the retention expiry time. For example, in response to receiving a request 116 associated with data 108 to alter data 108, controller 102 may compute a data survival time of data 108 based the segment survival time and based on the retention enabled time. In some examples, request 116 may be a modify request to modify data 108. In some examples, request 116 may be an erase request to erase data 108 from storage segment 106. Controller 102 may compare the data survival time to the retention expiry time to determine whether the retention period has lapsed. An example of determining whether the retention period has lapsed is described below.

For purpose of illustrating the example, computing device 100 may receive retention feature activation 110 at 11:00:00 on Oct. 15, 2014. The current kernel uptime, at the time of receiving retention feature activation 110, may be 10 days or 864000 seconds. The update period for the segment survival time and base kernel uptime may be every 30 seconds. The operation system executing on computing device 100 may be Unix.

Thus, controller 102 may:

set retention enabled time=1413370800 (Oct. 15, 2014, 11:00:00 in Unix time stamp);

set segment survival time=0;

set base kernel uptime=86400; and

schedule segment survival time and base kernel uptime update for every 30 seconds.

At 11:00:30, controller 102 may update the segment survival time and the base kernel uptime using a delta uptime. Controller 102 may use the delta uptime to increment the segment survival time and the base kernel uptime. Controller 102 may compute the delta uptime by computing a difference between the current kernel uptime and the base kernel uptime. Thus, at 11:00:30, controller 102 may:

set delta uptime=864030−864000 (current kernel uptime−base kernel uptime)=30;

set segment survival time=0+30 (segment survival time+delta uptime)=30; and

set base kernel uptime=864030.

At 11:01:00, controller 102 may update the segment survival time and the base kernel uptime again as follows:

set delta uptime=864060−864030 (current kernel uptime−base kernel uptime)=30;

set segment survival time=30+30 (segment survival time+delta uptime)=60; and

set base kernel uptime=864060.

At 12:00:00 on Oct. 15, 2014, computing device 100 may receive retention request 114. Retention request 114 may indicate that data 108 is to be retained for 5 days. In response to receiving retention request 114, controller 102 may compute an absolute segment survival time and a retention expiry time as follows:

absolute segment survival time=1413370800+3600 (retention enabled time+segment survival time)=1413374400; and

retention expiry time=1413374400+432000 (5 days in seconds) (retention enabled time+retention period)=1413806400.

At 12:00:30 on Oct. 15, 2014, computing device 100 may receive request 116 to modify or erase data 108. In response to receiving request 116, controller 102 may compute a data survival time of data 108 as follows:

data survival time=1413370800+3630 (retention enabled time+segment survival time)=1413374430.

Controller 102 may compare the data survival time to the retention expiry time to determine whether the retention period has lapsed. In this case, controller 102 may determine that the data survival time is less than the retention expiry time (1413374430<1413806400) based on the comparison. Thus, controller 102 may determine the retention period has not lapsed yet. Controller 102 may deny request 116 to modify or erase data 108.

However, when controller 102 determines that the data survival time is equal to greater than the retention expiry time, controller 102 may modify or erase data 108 as indicated by request 116. As an example, at 12:00:30 on Oct. 20, 2014, computing device 100 may receive request 116. In response to receiving request 116, controller 102 may compute the data survival time of data 108 as follows:

data survival time=1413370800+435630 (retention enabled time+segment survival time)=1413806430.

Controller 102 may compare the data survival time to the retention expiry time to determine whether the retention period has lapsed. In this case, controller 102 may determine that the data survival time is greater than the retention expiry time (1413806430>1413806400). Thus, controller 102 may determine that the retention period has lapsed. Controller 102 may modify or erase data 108 as indicated by request 116. In some examples, controller 102 may compute the data survival time periodically, such as every 60 seconds, to determine whether the retention period has lapsed.

By taking into account the retention enabled time and kernel uptime during the computation of the retention expiry time, controller 102 may correctly determine whether the retention period has lapsed even when the current system time is modified in an attempt to expire the retention period prematurely. For example, two days from the time at which retention request 114 is received at computing device 100. System clock 112 may be altered so that the current system time is changed to Nov. 15, 2014 in order to fake computing device 100 to expire the retention period. However, at this time, the segment survival time may be 176400 (time in seconds from 11:00:00, Oct. 15, 2014). Thus, the data survival time is:

1413370800+176400 (retention enabled time+segment survival time)=1413547200.

The data survival time may reflect the fact that data 108 has been retained for two days since the time at which retention request 114 is received. Thus, controller 102 may deny a request to modify or erase data 108 even if system clock 112 is altered. Thus, a reliability of a data retention operation may be increased.

In some examples, after computing the delta uptime during an update period, controller 102 may compare the delta uptime to a threshold to determine a validity of the delta uptime. For example, a threshold may be 2 seconds. Thus, if the refresh period is every 30 seconds and the delta uptime is more than 30±2 seconds, then controller 102 may determine that the current kernel uptime has been tampered and may power off computing device 100.

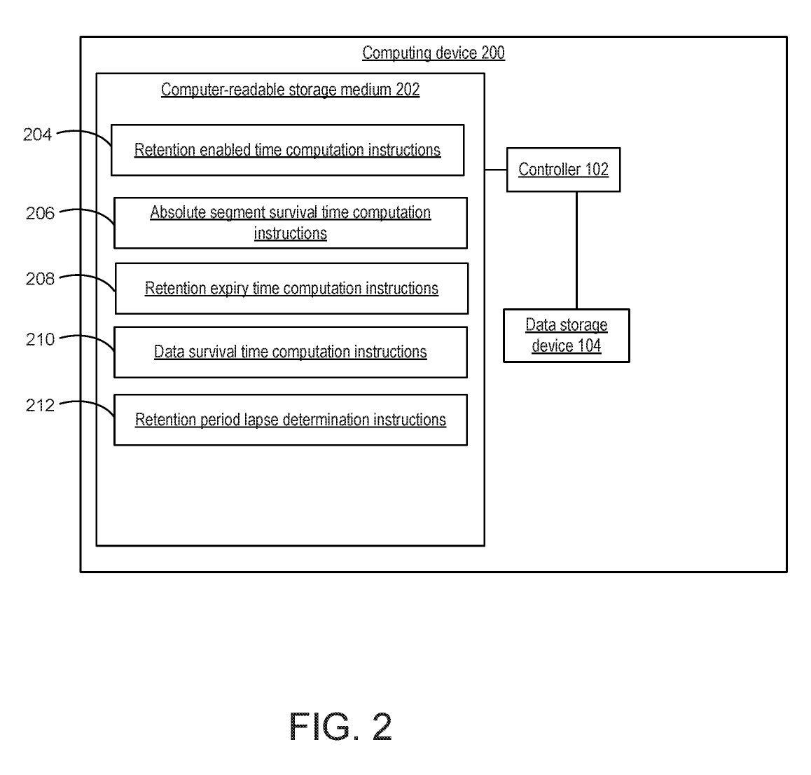

FIG. 2 is a block diagram of a computing device 200 including a data storage device to retain a data in a storage segment during a retention period, according to another example. Computing device 200 may implement computing device 100 of FIG. 1. Computing device 200 may include controller 102, a computer-readable storage medium 202, and data storage device 104.

Computer-readable storage medium 202 may be any electronic, magnetic, optical, or other physical storage device that contains or stores executable instructions. Thus, computer-readable storage medium 202 may be, for example, Random Access Memory (RAM), an Electrically Erasable Programmable Read-Only Memory (EEPROM), a storage device, an optical disc, etc. In some examples, computer-readable storage medium 202 may be a non-transitory storage medium, where the term “non-transitory” does not encompass transitory propagating signals. As described in detail below, computer-readable storage medium 202 may be encoded with a series of processor executable instructions 204-212 for computing a retention enabled time, computing an absolute segment survival time, computing a retention expiry time, computing a data survival time, and determining whether a retention period has lapsed. Controller 102 may fetch, decode, and execute instructions 204-212. As an alternative or in addition to retrieving and executing instructions, controller 102 may include at least one electronic circuit that includes electronic components for performing the functionality of instructions 204, 206, 208, 210, 212, or a combination thereof.

Retention enabled time computation instructions 204 may compute a retention enabled time in response to receiving a retention feature activation. For example, referring to FIG. 1, in response to receiving retention feature activation 110, controller 102 may compute a retention enabled time. Absolute segment survival time computation instructions 206 may compute an absolute segment survival time. For example, referring to FIG. 1, in response to receiving retention request 114, controller 102 may compute an absolute segment survival time based on the retention enabled time and based on the segment survival time.

Retention expiry time computation instructions 208 may compute a retention expiry time. For example, referring to FIG. 1, controller 102 may compute a retention expiry time of data 108 based on the absolute segment survival time and based on the retention period. Data survival time computation instructions 210 may compute a data survival time. For example, referring to FIG. 1, in response to receiving request 116, controller 102 may compute a data survival time. Retention period lapse determination instructions 212 may determine whether a retention period associated with data has lapsed. For example, referring to FIG. 1, controller 102 may compare the data survival time to the retention expiry time to determine whether the retention period has lapsed.

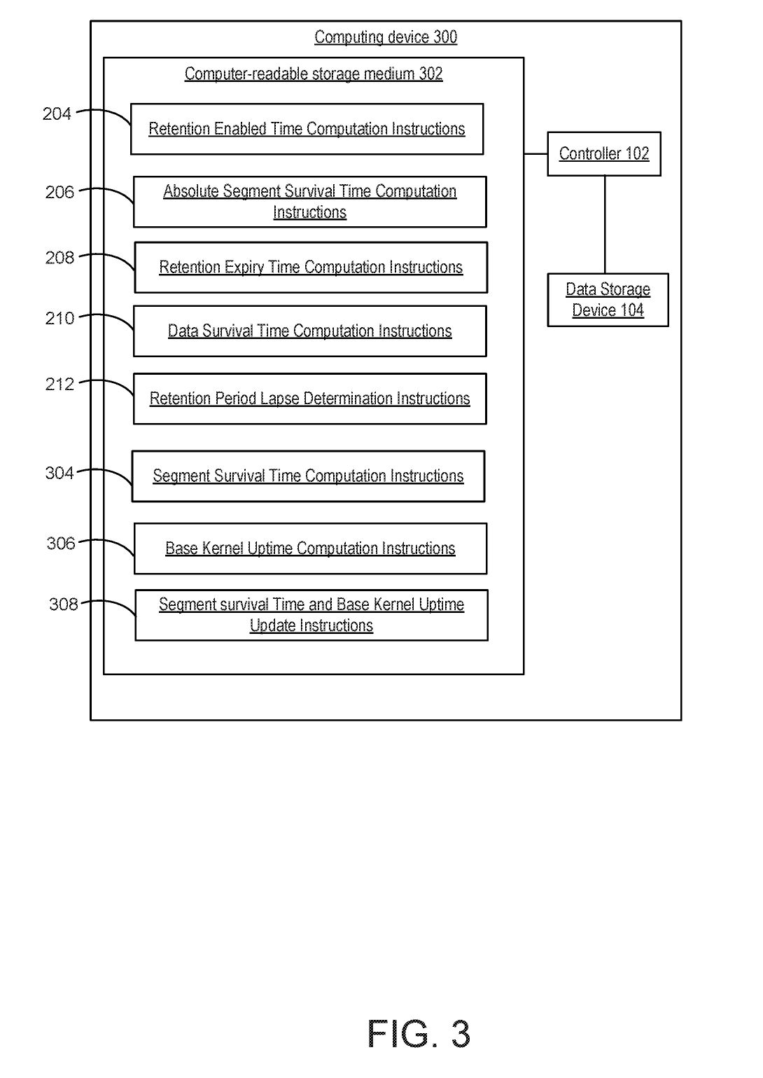

FIG. 3 is a block diagram of a computing device 300 including a data storage device to retain a data in a storage segment during a retention period, according to another example. Computing device 300 may implement computing device 100 of FIG. 1 and/or computing device 200 of FIG. 2. Computing device 300 may include controller 102, data storage device 104, a computer-readable storage medium 302. Computer-readable storage medium 302 may be similar to computer-readable storage medium 202.

Computer-readable storage medium 302 may be encoded with a series of processor executable instructions 204-212 and 304-308 that are executable by controller 102. Segment survival time computing instructions 304 may compute a segment survival time. For example, referring to FIG. 1, in response to receiving retention feature activation 110, controller 102 may also compute a segment survival time. Base kernel uptime computation instructions 306 may compute a base kernel uptime. For example, referring to FIG. 1, in response to receiving retention feature activation 110, controller 102 may further compute a base kernel uptime. Segment survival time and base kernel uptime update instructions may increment the segment survival time and the base kernel uptime using a delta uptime. For example, referring to FIG. 1, controller 102 may use the delta uptime to increment the segment survival time and the base kernel uptime.

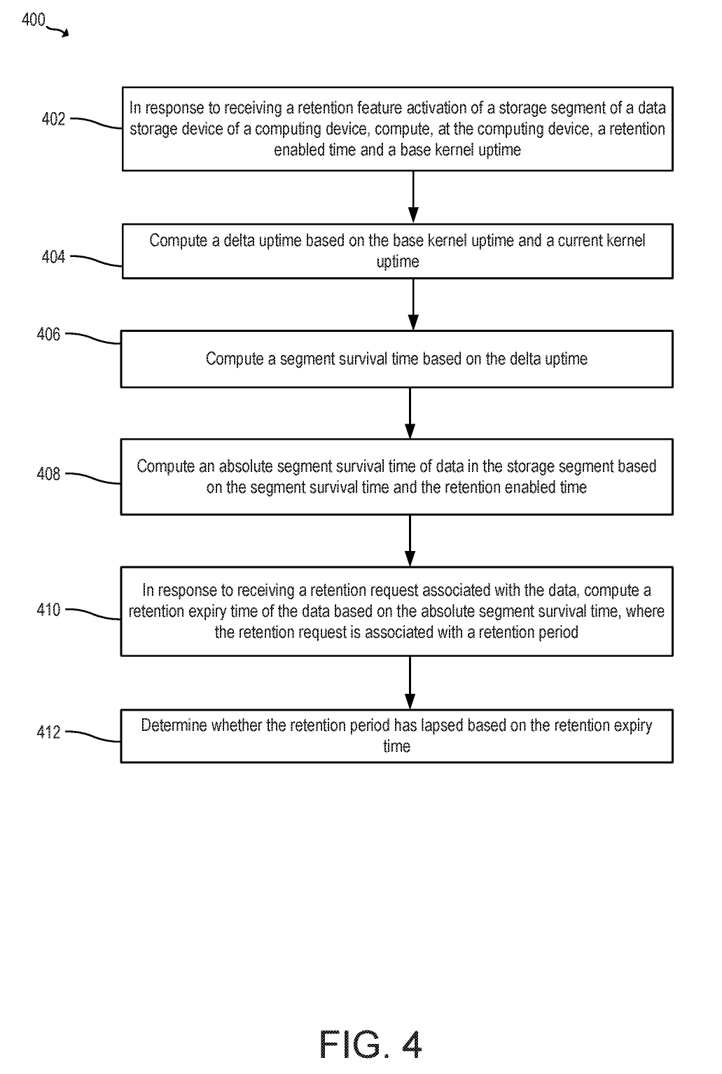

FIG. 4 is a flowchart illustrating a method 400 of operation at a computing device including a data storage device to retain a data in a storage segment during a retention period, according to an example. Method 400 may be implemented by computing device 100 of FIG. 1, computing device 200 of FIG. 2, and/or computing device 300 of FIG. 3.

Method 400 includes, in response to receiving a retention feature activation of a storage segment of a data storage device of a computing device, computing, at the computing device, a retention enabled time and a base kernel uptime, at 402. For example, referring to FIG. 1, in response to receiving retention feature activation 110, controller 102 may compute a retention enabled time. Method 400 also includes computing a delta uptime based on the base kernel uptime and a current kernel uptime, at 404. For example, referring to FIG. 1, controller 102 may compute the delta uptime by computing a difference between the current kernel uptime and the base kernel uptime.

Method 400 further includes computing a segment survival time based on the delta uptime, at 406. For example, referring to FIG. 1, controller 102 may use the delta uptime to increment the segment survival time and the base kernel uptime. Method 400 further includes computing an absolute segment survival time of data in the storage segment based on the segment survival time and the retention enabled time, at 408. For example, referring to FIG. 1, in response to receiving retention request 114, controller 102 may compute an absolute segment survival time based on the retention enabled time and based on the segment survival time.

Method 400 further includes, in response to receiving a retention request associated with the data, computing a retention expiry time of the data based on the absolute segment survival time, where the retention request is associated with a retention period, at 410. For example, referring to FIG. 1, controller 102 may compute a retention expiry time of data 108 based on the absolute segment survival time and based on the retention period. Method 400 further includes determining whether the retention period has lapsed based on the retention expiry time, at 412. For example, referring to FIG. 1, controller 102 may compare the data survival time to the retention expiry time to determine whether the retention period has lapsed.

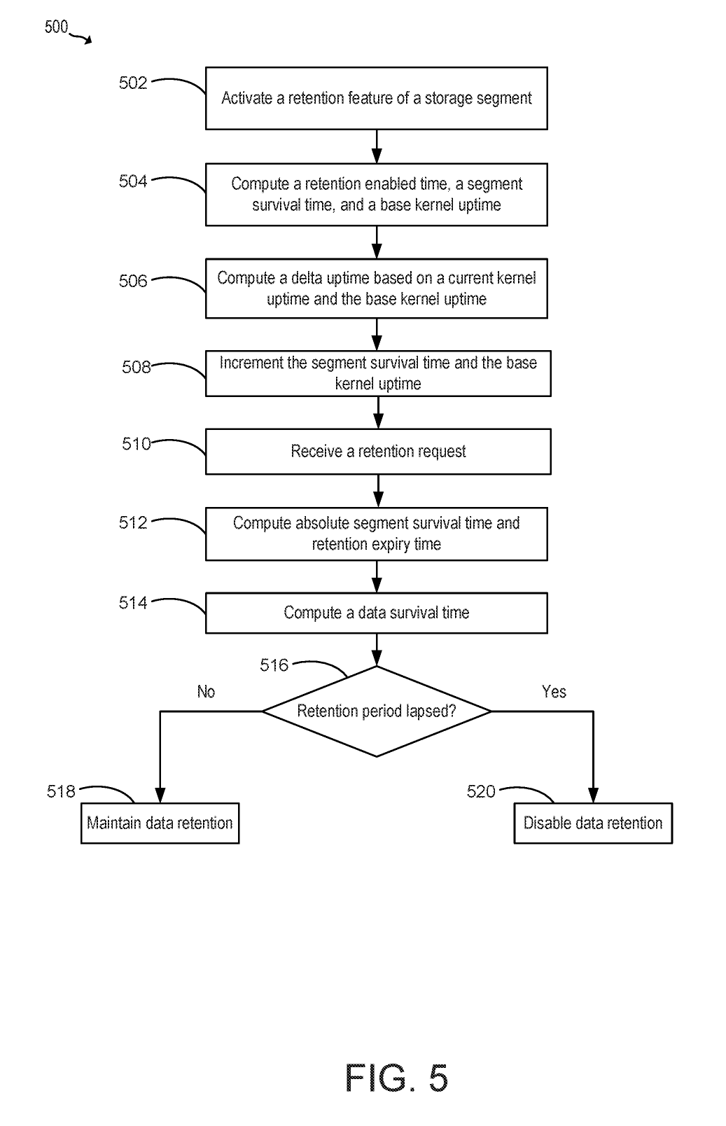

FIG. 5 is a flowchart illustrating a method 500 of operation at a computing device including a data storage device to retain a data in a storage segment during a retention period, according to an example. Although Method 500 is described with reference to computing device 100 of FIG. 1, it should be understood that method 500 may be implemented by computing device 100 of FIG. 1, computing device 200 of FIG. 2, and/or computing device 300 of FIG. 3.

At 502, controller 102 of computing device 100 may activate a retention feature of storage segment 106. Controller 102 may activate the retention feature in response to receiving retention feature activation 110. At 504, controller 102 may compute a retention enabled time, a segment survival time, and a base kernel uptime in response to activating the retention feature.

At 506, controller 102 may compute a delta uptime based on a current kernel uptime and the base kernel uptime. For example, controller 102 may compute the delta uptime as a difference between the current kernel uptime and the base kernel uptime. At 508, controller 102 may increment the segment survival time and the base kernel uptime. For example, controller 102 may increment the segment survival time and the base kernel uptime using the delta uptime periodically.

At 510, computing device 100 may receive a retention request associated with data to be retained, such as retention request 114 of FIG. 1. At 512, controller 102 may compute an absolute segment survival time and a retention expiry time. For example, controller 102 may compute the absolute segment survival time and the retention expiry time in response to receiving retention request 114 associated with data 108.

At 514, controller 102 may compute a data survival time. For example, controller 102 may compute the data survival time of data 108 in response to receiving request 116 to modify or erase data 108. In some examples, controller 102 may compute the data survival time periodically. At 516, controller 102 may determine if a retention period of data being retained has lapsed. For example, controller 102 may compare the data survival time to the retention expiry time to determine whether the retention period of data 108 has lapsed. At 518, in response to determining that the retention period has not lapsed, controller 102 may maintain data retention on the data so that the data may not be modified or erased. For example, controller 102 may deny request 116 to modify or erase data 108. At 520, in response to determining that the retention period has lapsed, controller 102 may disable data retention on the data so that the data may be modified or erased. For example, in response to determining that the retention period has lapsed, controller 102 may modify or erase data 108 as indicated by request 116.

The use of “comprising”, “including” or “having” are synonymous and variations thereof herein are meant to be inclusive or open-ended and do not exclude additional unrecited elements or method steps.

What is claimed is:

1. A computing device comprising:
a data storage device including a storage segment; and
a controller coupled to the data storage device, the controller to:
in response to receiving a retention feature activation of the storage segment, compute a retention enabled time of the storage segment;
in response to receiving a retention request associated with data in the storage segment:
compute an absolute segment survival time based on the retention enabled time; and
compute a retention expiry time of the data based on the absolute segment survival time, wherein the retention request is associated with a retention period; and
determine whether the retention period has lapsed based on the retention expiry time.

2. The computing device of claim 1, wherein the controller is further to set the retention enabled time based on a system clock of the computing device.

3. The computing device of claim 1, wherein the controller is further to compute the absolute segment survival time based on a segment survival time.

4. The computing device of claim 3, wherein the controller is further to update the segment survival time periodically.

5. The computing device of claim 1, wherein the controller is to determine whether the retention period has lapsed in response to receiving a erase request associated with the data or a modify request associated with the data.

6. A method comprising:
in response to receiving a retention feature activation of a storage segment of a data storage device of a computing device, computing, at the computing device, a retention enabled time and a base kernel uptime;
computing a delta uptime based on the base kernel uptime and a current kernel uptime;
computing a segment survival time based on the delta uptime;
computing an absolute segment survival time of data in the storage segment based on the segment survival time and the retention enabled time;
in response to receiving a retention request associated with the data, computing a retention expiry time of the data based on the absolute segment survival time, wherein the retention request is associated with a retention period; and
determining whether the retention period has lapsed based on the retention expiry time.

7. The method of claim 6, further comprising setting the retention enabled time based on a system clock of the computing device.

8. The method of claim 6, further comprising comparing the delta uptime to a threshold to determine a validity of the delta uptime.

9. The method of claim 8, wherein the delta uptime is valid when the threshold is greater than the delta uptime.

10. A non-transitory computer-readable storage medium comprising instructions that when executed cause a controller of a computing device to:
in response to receiving a retention feature activation of a storage segment of a data storage device of the computing device, compute a retention enabled time and a segment survival time;
in response to receiving a retention request associated with a data in the storage segment:
compute an absolute segment survival time of data in the storage segment based on the retention enabled time; and
compute a retention expiry time of the data based on the absolute segment survival time, wherein the retention request is associated with a retention period;
compute a data survival time of the data based on the segment survival time; and
determine whether the retention period has lapsed based on a comparison between the data survival time and the retention expiry time.

11. The non-transitory computer-readable storage medium of claim 10, wherein the instructions when executed further cause the controller to set the retention enabled time based on a system clock of the computing device.

12. The non-transitory computer-readable storage medium of claim 10, wherein the retention period has lapsed when the data survival time is greater than the retention expiry time.

13. The non-transitory computer-readable storage medium of claim 10, wherein the instructions when executed further cause the controller to increment the segment survival time periodically.

14. The non-transitory computer-readable storage medium of claim 13, wherein the instructions when executed further cause the controller to increment the segment survival time based on a difference between a current kernel uptime and a base kernel uptime.

15. The non-transitory computer-readable storage medium of claim 10, wherein the data survival time is computed in response to receiving a erase request associated with the data or a modify request associated with the data.
